(19) United States
(12) Patent Application Publication
(10) Pub. No.: US 2007/0176009 A1
(43) Pub. Date: Aug. 2, 2007

(54) THERMOSTATIC VALVE

(76) Inventor: Markus Gebauer, Stuttgart (DE)

Correspondence Address: STRIKER, STRIKER & STENBY, 103 EAST NECK ROAD, HUNTINGTON, NY, 11743, US

(21) Appl. No.: 11/623,121

(22) Filed: Jan. 15, 2007

(30) Foreign Application Priority Data
Jan. 28, 2006 (DE) 10 2006 004 053.8

(51) Int. Cl. G05D 23/02

(52) U.S. Cl. 236/101 R

(57) ABSTRACT

A thermostatic valve has a housing; a valve seat which surrounds a valve housing at both sides; valve chambers provided on the both sides for an inflow and an outflow of a medium; a thermostat element having at least one valve element controlling the valve opening; and a housing retaining at least one valve element braced with a relatively displaceable part; a restoring spring with urges said valve element in a closing direction and is braced on one end on the housing or the valve element and on another end on an abutment that is held on the valve housing by means of struts, the valve housing having a separate component on which at least the struts for the abutment are configured integrally, the component has heavy-duty material and being integral with the valve housing.

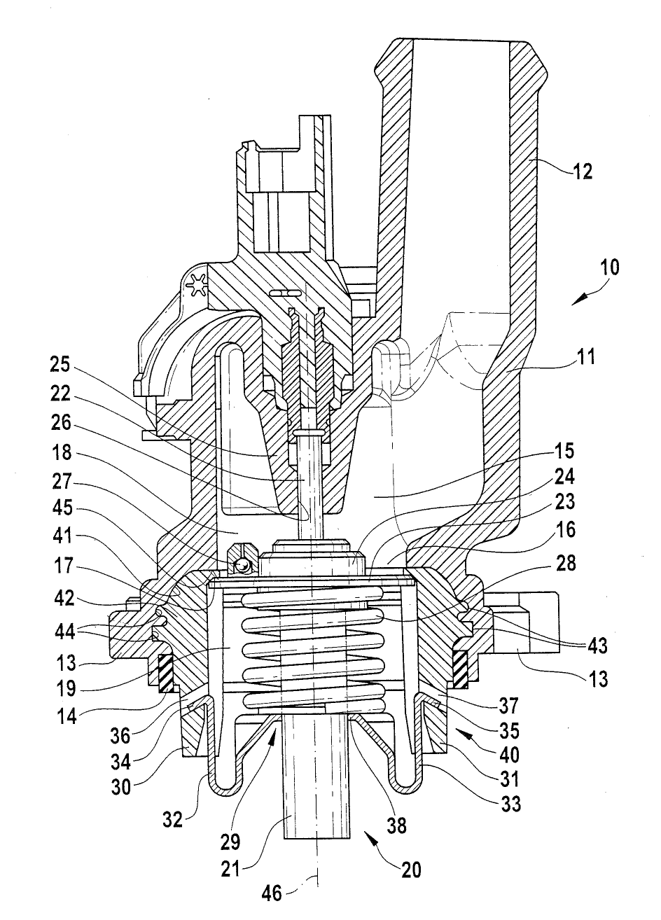

### CROSS-REFERENCE TO A RELATED APPLICATION

The invention described and claimed hereinbelow is also described in DE 10 2006 004 053.8, filed Jan. 28, 2006. This German Patent Application, whose subject matter is incorporated here by reference, provides the basis for a claim of priority of invention under 35 U.S.C. 119 (a)-(d).

### BACKGROUND OF THE INVENTION

The invention relates to a thermostatic valve.

A thermostatic valve of this type is known (European Patent Disclosure EP 0 600 150 B1), in which the valve housing comprises a cap part that is provided with a tubular attachment integral with it and that approximately at the level of the valve opening and the valve seat has an annular part, into which the valve seat is machined. Two approximately diametrically opposed struts are integral with the annular part and are embodied as short struts for suspending an abutment bracket. So that such a valve will durably withstand the stresses to which this valve, in particular the one-piece valve housing, is exposed, it is necessary to produce the one-piece valve housing of suitable plastic material that meets the requirements. This is expensive.

### SUMMARY OF THE INVENTION

The object of the invention is to create a thermostatic valve of the type referred to at the outset which assures high dimensional stability and great durability of the valve housing, without changing the operating range of the valve.

In keeping with these objects and with others which will become apparent hereinafter, one feature of the present invention resides, briefly stated, in a thermostatic valve, comprising a housing; a valve seat which surrounds a valve housing at both sides; valve chambers provided on said both sides for an inflow and an outflow of a medium; a thermostat element having at least one valve element controlling said valve opening and a housing retaining at least one valve element braced with a relatively displaceable part; a restoring spring with urges said valve element in a closing direction and is braced on one end on said housing or said valve element and on another end on an abutment that is held on the valve housing by means of struts, said valve housing having a separate component on which at least said struts for said abutment are configured integrally, said component comprising heavy-duty material and being integral with said valve housing.

Because the valve housing has a separate component, on which at least the struts for the abutment are embodied integrally; and wherein the component comprises heavy-duty plastic or metal and is injected or cast integrally into the valve housing which for instance comprises standardized plastic material, a thermostatic valve with reduced production costs and in which the dimensional stability and durability of the entire valve housing, and in particular of at least the struts, is substantially increased is created in a simple way. It is understood that with regard to the special shaping of the struts and of the abutment cooperating with them, the special characteristics can equally well be used in addition that are described and shown in EP 0 600 150 B1, which is hereby expressly incorporated by reference to avoid repeating these special characteristics.

Advantageously, the separate component is formed for instance of PPS plastic material, which withstands even strong forces. The rest of the valve housing, conversely, may be formed of PA, for instance, and thus of substantially less-expensive plastic material. As a result of this pairing of materials, the costs for the thermostatic valve can be reduced markedly, while simultaneously assuring that the elements which are exposed to particular forces and stresses can withstand them.

Further details and advantages of the invention will become apparent from the ensuing description.

The claims are not repeated in full below, solely to avoid unnecessary repetition; the claims are referred to by simply being mentioned, yet all the characteristics of the claims are considered to be expressly disclosed and in a way that is essential to the invention at this point. All the characteristics mentioned above and in the ensuing description as well as the characteristics that can be learned solely from the drawing are understood to be further components of the invention, even if they are not especially emphasized and in particular even if they are not mentioned in the claims.

The invention is described in further detail below in terms of an exemplary embodiment shown in the drawing.

### BRIEF DESCRIPTION OF THE DRAWINGS

The sole FIGURE of the drawing is a view that schematically shows a vertical section with a partial side view of a thermostatic valve in accordance with the present invention.

### DESCRIPTION OF THE PREFERRED EMBODIMENTS

In the drawing, a thermostatic valve 10 is shown, which is in its closing position. The valve 10 has a valve housing 11 with an integral tubular attachment 12 for connection to a line, not shown. On the side located at the bottom in the drawing, the valve housing 11 is open and has an annular part 13, which when the valve housing 11 is secured to a housing, not otherwise shown, rests on that housing; between the annular part 13 and the housing, not shown, sealing is done by means of a sealing ring 14.

In its interior 15, the valve housing 11 includes a valve opening 16, which is surrounded by a valve seat 17. On both sides of the valve opening 16, valve chambers 18 and 19 are formed, which serve the purpose of the inflow and outflow of a medium to be controlled.

The valve 10 furthermore has a thermostat element 20, which is embodied as an expansion element, for instance, and has a housing 21 containing material, such as wax, that expands when the temperature is increased; a piston 22, which in its interior may have a heating device, not further shown, plunges into the housing 21 and in particular into the expandable material contained in it. The piston 22 and the housing 21 of the thermostat element 20 are displaceable relative to one another as a function of the heating or cooling of the expandable material contained in the housing 21. The thermostat element 20, on its housing 21, has a valve element 23, which is for instance plate-shaped and which is braced on a housing step 24 in one direction.

The valve element 23 cooperates with the valve seat 17 in the valve housing 11 to control the valve opening 16. In the position shown, the platelike valve element 23 is seated on the valve seat 17 and closes the valve opening 16, so that no flow of medium between the valve chambers 18 and 19 is possible. Conversely, if the valve element 23 is moved downward in terms of the drawing, then it lifts away from the valve seat 17, uncovering the valve opening 16, so that a passage of medium between the valve chambers 18 and 19 is possible in the region of the valve opening 16.

The valve housing 11, at a spacing above the valve opening 16, includes a bracing member 25, which is integral with the valve opening, with a bore 26 that is open at the bottom, and this bore is engaged by a piston 22 that is braced axially in it at the end. With reference numeral 27, an additional ball valve, known per se, that is integrated with the valve element 23 is schematically indicated.

The valve element 23 is urged in the valve closing direction by a restoring spring 28, which is embodied here for instance as a cylindrical helical spring, which surrounds the housing 21 and is braced with its upper end, in terms of the drawing, on the valve element 23, or on the housing 21 if the valve element 23 is solidly and nondisplaceably joined to the housing 21. The other end, located at the bottom in the drawing, of the restoring spring 28 is braced on an abutment 29, which is retained by means of struts, for instance two struts 30, 31, on the valve housing 11.

The struts 30, 31 may be diametrically opposite one another and may be formed similarly to downward-protruding arms, of the kind shown and described in EP 0 600 150 B1, for example. The abutment 29 has legs 32 and 33, for instance on both sides, with hooks 34 and 35, respectively, on their ends that are capable of engaging associated suspension openings 36, 37 of the struts 30, 31. The legs 32, 33 are joined via a transverse part 38 that is integral with them and that has an opening in the center for the housing 21 extending through it. The special design of the struts 30, 31 and legs 32, 33 with the respective hooks 34 and 35 may be selected in accordance with EP 0 600 150 B1.

The valve housing 11 has a separate component 40, on which at least the struts 30, 31 for the abutment 29 are embodied integrally. This component 40 is molded from metal or in particular from a heavy-duty plastic material, in material from polyphenylene sulfide (PPS). The component 40 is injected or cast integrally into the valve housing 11, which comprises a different, for instance standardized, plastic material, and in every case in the molding of the valve housing 11 is placed in the mold and formed with it into a housing. In the production of the valve housing 11, the component 40 is injected or integrally cast into the valve housing. The valve housing 11 for instance comprises polyamide (PA). This material is adequate for the stresses to which the valve housing 11 is exposed. The heavy-duty plastic material that conversely comprises the component 40 is capable of withstanding the stresses to which this component 40 is exposed, particularly with respect to the struts 30, 31, in particular the forces that are operative from the restoring spring 38 and that are operative in the closing position of the valve 10 and in particular in the opening motion, in which the restoring spring 28 is compressed more severely.

These force problems are known per se and are also described in EP 0 600 150 B1, to which a reference is made. Because only the component 40 with at least the struts 30, 31 is formed of suitable heavy-duty plastic material and thus of expensive material, while the remainder of the valve housing 11 is of standardized plastic material, which is less expensive, the material design and thus the costs of the stresses to which this valve 10 is exposed are especially important. As a result, the valve 10 is on the one hand economical and on the other sturdy to a high degree and thus assures a long service life. There is no risk of any creeping of the material comprising the struts 30, 31. The operating range of the valve 10, which is set in its production, does not change over the course of time.

The valve housing 11 has an inner annular receptacle 41, to which the component 40 is adapted and into which this component 40 is injected or integrally cast. The component 40 has an annular part 42, which is adapted to the annular receptacle 41 and is contained in the annular receptacle 41, and the annular part 42 defines a valve chamber 19 located on one side of the valve opening 16. Between the valve housing 11 and the separate component 40, form-locking armature means are operative, which are formed on the one hand of at least one radially projecting protrusion 43 and on the other at least one radial recess 44 associated with this protrusion 43, which recess is engaged by the at least one protrusion 43.

In the exemplary embodiment shown, two axially spaced-apart struts or ribs, which are integral with the component 40, are for instance provided as the protrusions 43. Grooves or slots corresponding to these struts or ribs are provided as recesses 44 and are contained in the annular receptacle 41 of the valve housing 11. Annular ribs extending all the way around can also be provided as radially projecting protrusions 43, and grooves extending all the way around may be provided as suitably adapted recesses 44. Armature means which are embodied as threads or at least similar to threads may also be advantageous. Individual radially protruding pins as protrusions 43 and bores associated with them as recesses 44 are likewise within the scope of the invention, as are all other armature means familiar to skilled in the art that are operative in form-locking fashion.

In the exemplary embodiment shown, the component 40 is designed such that on its annular part 42, struts 30, 31 protruding approximately axially parallel from it are embodied, with suspension openings 36, 37 for the legs 32, 33 of a bracketlike abutment 29. In the exemplary embodiment shown, the valve opening 16 and the valve seat 17 surrounding it are also part of the component 40 and are embodied integrally with it. Thus the regions of the component 40 that are subject to tensile stress by the action of the restoring spring 28 are formed from metal or heavy-duty plastic material. The annular receptacle 41 of the valve housing 11 is provided, approximately in the axial region of the valve seat 17, with a bottom face 45 that extends in a plane which extends approximately perpendicular to the longitudinal center axis 46 of the thermostat element 20.

In the associated region, the annular part 42 extends in approximately domelike fashion, forming an end face which extends correspondingly to the bottom face 45 and with which the component 40 is braced axially on the bottom face 45. Because of this domelike construction, good, precise radial centering and axial bracing of the component 40 inside the annular receptacle 41 is achieved, and thus a replicable relative position of the component 40 with respect to the valve housing 11, which promotes production by secure processes.

In another exemplary embodiment, not shown, the component 40 comprises only the annular part 42 and the struts 30, 31 integral with it, and the valve seat face 17 is part of the valve housing 11 rather than of the component 40.

In another exemplary embodiment, not shown, the protruding struts 30, 31 are joined to one another at the end via a transverse part, which is integral with them and on which the associated end of the restoring spring 28 is braced. This transverse part that is integral with the struts 30, 31 forms the abutment for the restoring spring 28, so that a separate insertable bracket with legs 32, 33 and a transverse part 38 is not needed. It is understood that this kind of transverse part that is integral with the struts 30, 31 is provided, in the same way as the transverse part 38, with a central opening for the housing 21. Once again, the component 40 may be of such a nature that the valve seat 17 is also formed integrally with it. Instead, the annular part 42 may end at a spacing from a valve seat 17 that is embodied on the valve housing 11.

It will be understood that each of the elements described above, or two or more together, may also find a useful application in other types of constructions differing from the types described above.

While the invention has been illustrated and described as embodied in a thermostatic valve, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A thermostatic valve, comprising a housing; a valve seat which surrounds a valve housing at both sides; valve chambers provided on said both sides for an inflow and an outflow of a medium; a thermostat element having at least one valve element controlling said valve opening and a housing retaining at least one valve element braced with a relatively displaceable part; a restoring spring with urges said valve element in a closing direction and is braced on one end on said housing or said valve element and on another end on an abutment that is held on the valve housing by struts, said valve housing having a separate component on which at least said struts for said abutment are configured integrally, said component comprising heavy-duty material and being integral with said valve housing.

2. A thermostatic valve as defined in claim 1, wherein said thermostat element is configured as an expansion element.

3. A thermostatic valve as defined in claim 1, wherein said relatively displaceable part is configured as a piston.

4. A thermostatic valve as defined in claim 1, wherein said valve housing is composed of plastic material.

5. A thermostatic valve as defined in claim 1, wherein said separate component is a component selected from the group consisting of a component injected integrally into said valve housing and a component cast integrally into said valve housing.

6. A thermostatic valve as defined in claim 1, wherein said valve housing has an inner annular receptacle, said separate component being configured as a component selected from the group consisting of a component injected integrally into said inner annular receptacle and a component cast integrally into said inner annular receptacle.

7. A thermostatic valve as defined in claim 1, wherein said valve housing has an annular receptacle, said separate component having an annular part which is contained in said annular receptacle.

8. A thermostatic valve as defined in claim 7, wherein said annular part defines one of said valve chambers that is located on one side of said valve opening.

9. A thermostatic valve as defined in claim 1; and further comprising form-locking armature means operative between said valve housing and said separate component.

10. A thermostatic valve as defined in claim 9, wherein said armature means is configured to be composed of at least one radially projecting protrusion and at least one radial recess associated with said protrusion, which recess is engaged in form-locking fashion by said at least one protrusion.

11. A thermostatic value as defined in claim 10, wherein said at least one protrusion is configured as a element selected from the group consisting of a strut, a pin and a recess, while said at least one recess is configured as an element selected from a group consisting of a bore and a groove.

12. A thermostatic value as defined in claim 7, wherein on said annular part, said struts protruding from it are configured with suspended openings for legs of an abutment bracket.

13. A thermostatic valve as defined in claim 7, wherein on said annular part, said struts protruding from it, which are joined on one end to one another via a transverse spot that is integral with them, are configured for bracing said restoring spring.

14. A thermostatic valve as defined in claim 7, wherein said annular part ends at a spacing from said valve seat that is configured on said valve housing.

15. A thermostatic valve as defined in claim 7, wherein on said annular part, said valve opening is configured integrally with said valve seat surrounding it.

16. A thermostatic valve as defined in claim 1, wherein said separate component is composed of a material selected from the group consisting of heavy duty plastic and metal.

17. A thermostatic valve as defined in claim 1, wherein said separate component is composed of a polyphenylene sulfide.

18. A thermostatic valve as defined in claim 1, wherein said valve housing is composed of polyamide.
